(19) United States
(12) Patent Application Publication
(10) Pub. No.: US 2017/0240753 A1
(43) Pub. Date: Aug. 24, 2017

(54) METHOD FOR PRODUCING PAINTS BY MEANS OF MIXING FLUID PRODUCTS

(71) Applicant: ALFA S.R.L., Bologna (IT)

(72) Inventors: Edoardo ROSSETTI, Bologna (IT); Marco ROSSETTI, Bologna (IT)

(21) Appl. No.: 15/517,786

(22) PCT Filed: Oct. 15, 2015
(86) PCT No.: PCT/IB2015/057914

§ 371 Date: Apr. 7, 2017

(30) Foreign Application Priority Data
Oct. 15, 2014 (IT) BO2014A000562

(51) Int. Cl. C09D 7/14; B65B 3/04; C09D 5/02

(52) U.S. Cl. CPC C09D 7/14; C09D 5/022; B65B 3/04

(57) ABSTRACT

In a method for producing paints by means of mixing fluid products, there is provided a group of fluid products comprising at least one white paint, containing a predetermined percentage quantity of titanium dioxide, and at least one neutral paint which does not have colorants. There is then provided an empty container which is filled with a predetermined quantity of paint which is obtained by mixing the white paint and the neutral paint at variable proportions between 0% and 100%. There is obtained a resultant paint which has a content of titanium dioxide which is selected between a maximum, corresponding to the content of titanium of the white paint, and 0%, corresponding to the content of titanium of the neutral paint.

### FIELD OF THE INVENTION

The present invention relates to a method for producing paints by means of mixing fluid products.

### TECHNOLOGICAL BACKGROUND

In the present description, the term “paint” is used to indicate the various fluid products which are used in various fields in order to decorate surfaces, such as, for example, clear or opaque enamels for wood or metal, water paints for walls, internal or external walls, of the washable type, breathable type, single coat type, etc. The term “paint” is also intended to include fluid colouring products for cosmetic use, such as enamels for nails, dyes for hair, etc.

Paints generally comprise the following elements or groups of elements which define the chemico-physical properties thereof:
one or more binding or film-forming substances which confer on the paint durability and brilliance of the finished surfaces, such as, for example, synthetic resins, such as polyurethane, acrylic, epoxy, alkyd, phenolic, styrenic resins, as well as the derivatives of cellulose, such as, for example, nitrocellulose and acetocellulose; natural resins, such as, for example, copal, also belong to this group;
filling substances or “fillers”, such as, for example, calcium carbonate CaCO₃, which give body and coverage to the paint;
various additives, such as dispersing compounds, anti-fermentation compounds, siccatives, anti-skinning compounds, etc.

The above-mentioned elements are dispersed in a diluents agent which is nowadays mainly water, even if there are a number of paints which use a mineral or organic solvent.

The paints normally take on various colourations as a result of coloured pigments which are dispersed therein. The colorant mainly used is titanium dioxide TiO₂, which confers on the paint a white coloration or which is used to lighten other shades, produced, for example, by mixing pigments which provide a coloration which is yellow, red, cyan, black, etc.

The paints can be produced in great quantities in industrial plants in which the various components are supplied individually in great mixing receptacles. The production of paints in the industrial plants poses the problem of distribution of the paints at the points of sale, the storage thereof and the conservation thereof, which is aggravated by the fact that it is necessary to conserve on shelving a variety of paints which are not only different owing to the quality and type of application, but for each of which it is necessary to provide a rather large variety of different colorations.

The paints can also be produced at the point of sale by means of mixing fluid products in situ. A widespread method, the tintometric system, provides for the storage of a given number of containers (tins, cans, etc.) which are filled with a base product, which is generally white in colour and which is coloured where necessary by means of a colorant dispensing machine which is positioned at the point of sale. The colorant dispensing machines have on-board a given number of tanks of colorants which are discharged at predetermined quantities in accordance with formulations which are devised by each paint producer, in the containers filled with the base product, so as to obtain a finished paint having the desired coloration. With those systems, it is difficult to produce very dark colour shades, for which it is necessary to use a substantial quantity of colorant in order to balance the white of the base product. It is further impossible to obtain pure dark colours, such as the colour black.

In order to improve the use of colorants in the dispensing systems, there have been proposed methods which use a given number of base products which are different from each other owing to the quantity of titanium dioxide contained. In that manner, it is possible to use a base product with a high quantity of titanium dioxide in order to produce finished products having a very clear or pale coloration while it is possible to use a base product with an extremely low quantity of titanium dioxide in order to produce finished products which have a very dark coloration. The disadvantage of those methods is that it is necessary to store a given number of containers of base products which are different from each other, with an evident increase in the costs and the complexity of administration of the supplies.

At the retail points of sale, there is a necessity to provide for clients small quantities of paints, for example, in containers of 200 cc or less, with a chromatic selection which is as wide as possible. Non-professional clients may, for example, use those paints for small pieces of domestic work, while professional clients may use them as samples in order to visualise or show chromatic effects on a limited scale before starting large decorating jobs.

In order to satisfy that requirement, there have been proposed dispensing machines which use the known tintometric systems and which are suitable for discharging small quantities of colorant in cans previously filled with a base paint containing a predetermined quantity of titanium dioxide. Those machines have to be used by skilled operators who have to take from the store the base paint container with the content of titanium dioxide which is most appropriate for the formulation of the colour desired, open the container and place it under the discharge nozzle of the dispensing machine, take and close the container at the end of the discharge operation and finally agitate the container by means of an agitating machine.

There are dispensing machines which integrate therein the agitator, or a store of containers of white base paints, but they do not solve the main problem of the high level of stock of products necessary for ensuring a good continuity of service, and do not eliminate the need for skilled operators who intervene in at least some steps of the method. Furthermore, those machines are generally very complex and costly.

There have also been proposed solutions which use machines of small size which at the point of sale provide for the production of the paints which, as in the industrial plants, provide for mixing of all the components necessary for the production of a finished paint. Those machines are necessarily complex, require tanks which have large dimensions in order to contain the binding products, fillers and additives which are capable of ensuring a given autonomy of operation. Furthermore, the binding products, fillers and additives pose per se problems of conservation and require specific arrangements for the storage and handling thereof.

In a generally theoretical manner, there have been proposed solutions which use transparent base products, to which coloured pigments and titanium dioxide are added only when the finished paint is prepared. However, those systems have not been used, until now, in any practical applications, presumably because they do not represent a significant improvement with respect to the conventional tintometric systems. In fact, it would still be necessary to store a number of base products which are different for each quality of finished paint which it is desirable to obtain.

### STATEMENT OF INVENTION

The present invention proposes that the disadvantages of the prior art be overcome by means of a method for mixing fluid products, which allows the production of finished paints at a point of sale, even in small quantities, with a wide selection of coloration, substantially reducing the storage space necessary for the storage of the products. In order to achieve those objectives, the invention relates to a method defined in the appended claims. The invention also relates to a machine which is specifically suitable for carrying out that method.

According to a first aspect, there is provision for two finished paints having a predetermined quality to be provided, one white containing titanium dioxide and the other neutral without any titanium dioxide. Preferably, there are also provided some fluid colouring products of the generally known type (yellow, red, cyan, black, etc.). The two paints, white and neutral, are mixed selectively in accordance with predetermined formulations inside in order to obtain a final paint having the predetermined quality and a desired content of titanium dioxide. By mixing the white paint and the neutral paint in variable proportions between 0% and 100%, there is produced a resultant paint which has a content of titanium dioxide which is selected between a maximum corresponding to the content of titanium of the white paint and 0% corresponding to the content of titanium of the neutral paint.

In short, there is produced a finished paint which has a content of titanium dioxide which is optimized in accordance with the colour to be obtained. In the case of a grey colour, it is simply necessary to mix the white paint and the neutral paint in volumetric quantities which are between 0% and 100%, respectively. In order to obtain a chromatically different paint from grey, there is added to the paint resulting from the mixing of from 0% to 100% of the white paint and the neutral paint a variable proportion of one or more fluid colorant components. In this manner, it is possible to produce formulations of paints with an optimum final quantity of colorants, without exceeding the quantity necessary for obtaining the chromatic gradation desired.

Advantageously, the variable proportions from 0% to 100% of the white paint and the neutral paint are determined by volume and discharged by a volumetric dispensing device, for example, a dispensing machine for fluid products.

According to a particular aspect, the white paint and the neutral paint each comprise at least one binding emulsion, at least a quantity of fillers and at least a quantity of additives. Those products in the two paints, the white paint and the neutral paint, are mutually compatible so as to promote the compatible mixing of the white paint and the neutral paint during the production of the resultant paint.

Advantageously, the method provides, at the end of the filling operation, for the container to contain a resultant quantity of paint which is equal to or greater than 50 cc, and preferably less than several litres, for example, less than 15 or 20 litres. This allows the production of finished paints at the point of sale, providing, for example, machines with tanks for the white paint and the neutral paint having a maximum capacity of approximately 1000 litres. Tanks having that capacity may be placed in machines which are not too bulky, still ensuring a good production capacity of finished paints for the public before it is necessary to refill the tanks.

Preferably, but in a non-limiting manner, in the method it is possible to readily produce containers having test samples whose content does not exceed 200 cc.

An advantage of the present invention is the absence of any need to store pre-filled containers of base paint. Another advantage involves the fact that it is possible to produce finished paints in the quantities precisely desired, to discharge them into empty containers which are available at the point of sale or provided directly by the end user. Another advantage involves the fact of being able to produce a very wide range of colorations, without the limitations of the known systems which do not allow correct reproduction of colorations which are very dark. Another advantage involves the possibility of implementing formulations of finished paints which reproduce in a precise manner standard chromatic systems, such as, for example, the Pantone® system.

Therefore, the solution proposed by the present invention provides for optimization of the production system of paints at the point of sale, eliminating the compromise of the known tintometric systems and eliminating the storage of the known solutions.

By means of the present invention, it is further possible to optimize the quantity of colorants necessary to obtain a given coloration of the finished paint.

According to another aspect of the invention, it is possible to produce samples of paints in cans of small capacity, for example, from 50 cc or 100 cc, up to several litres. The individual characteristic according to which the can in which the fluid products are intended to be dispensed is initially empty allows a great flexibility in terms of production of samples of paints, with little perishable material stored because the paints are completely maintained on-board a machine, under ideal and controlled conditions of conservation and agitation.

Additional features and advantages will be appreciated from the following detailed description of embodiments which are given purely by way of non-limiting example of the invention.

### DETAILED DESCRIPTION

In a specific but non-limiting embodiment, the method of the present invention makes provision for a white paint and a neutral paint to be provided.

The white paint comprises approximately 25% by volume of emulsion, that is to say, of the binding component which confers adhesion on the paint. The emulsion is, for example, based on homopolymer, vinyl copolymer or it is acrylic, styrene-acrylic, silicone-containing, siloxane, acryl-siloxane, or based on other compounds of the generally known type. The white paint further comprises approximately 25% of titanium dioxide TiO₂ which provides it with the white coloration. The white paint further comprises approximately 25% of fillers which confer thickness on the paint. There may be indicated as examples of filler calcium carbonate, kaolin, barium sulphate, dolomite, or other compounds which are known in the sector of paints. The white paint further comprises a small percentage of additives, for example, from 0.1 to 0.4%, which are selected from the group, for example, comprising cellulose, which confers the paintability and distension on the paint, antibacterial substances, for better conservation of the paint, coalescent substances, wetting agents and dispersant substances. The whole is dispersed in water.

The neutral paint comprises approximately 35% by volume of emulsion, which is compatible with and preferably similar to the emulsion of the white paint. The neutral paint further comprises approximately 40% of fillers which are also compatible with and preferably similar to those of the white paint. The neutral paint further also comprises a small percentage of additives, for example, from 0.1% to 0.4%, which are selected from the group, for example, comprising cellulose, which confers the paintability and distension on the paint, antibacterial substances, for better conservation of the paint, coalescent substances, wetting agents and dispersant substances. The whole is dispersed in water.

In order to produce a finished paint having a predetermined colour, the white paint and the neutral paint are mixed together in a selected proportion of from 0% to 100% so as to form a finished paint with a predetermined content of titanium dioxide, to which there are added various colorants, generally in small or extremely small quantities, in order to obtain the desired chromatic tonality. At the extremes of the chromatic range, the white paint and the neutral paint are used in a pure state, that is to say, in other words, mixed in proportions of 0% of one and 100% of the other. For example, in order to produce pastel colorations, there is provision for using the white paint, to which there is added small or extremely small quantities of a yellow, red, black colorant, etc.

For paints having a coloration which is more intense, there is carried out the mixing of the white paint and the neutral paint in predetermined proportions in order to optimize the content of titanium dioxide. For example, if it is desirable to produce an intermediate grey colour, it is possible to mix 50% of the white paint and the neutral paint, obtaining a paint having a final content with approximately 32% of emulsion, approximately 14.5% of titanium dioxide, approximately 34.5% of fillers. That intermediate paint, which is optimized in order to obtain a predetermined chromatic range of a colour chart, is then coloured by a selection of predetermined colorants.

In the same manner, the white paint and the intermediate paint can be mixed together in any relative proportions, from 0% to 100%, with the sole limitation being given by the minimum resolution of the mixing device, normally a positive-displacement pump. In this manner, it is possible to obtain a paint having a grey tonality with a content of titanium dioxide which is optimized in order to obtain a paint having the desired chromaticity and the predetermined properties involving coverage, adhesion, paintability, etc., and in particular not inferior in terms of quality to the respective characteristics of the white paint, on the one hand, and the neutral paint, on the other hand.

Advantageously, the resultant quality of the finished paint is predetermined and is not inferior to the quality of the white paint, on the one hand, and the neutral paint, on the other hand. Furthermore, the intermediate quality of the paint resulting from the mixing of the white paint and the neutral paint can be optimized in accordance with the colour to be obtained, without the compromises of the known systems which use bases having a predetermined content of titanium dioxide.

Naturally, the principle of the invention remaining the same, the forms of embodiment and construction details may be varied widely with respect to those described and illustrated, without thereby departing from the scope of the present invention.

1. A method for producing paints by means of mixing fluid products comprising the following steps:
providing a group of fluid products comprising:
at least one white paint, containing a predetermined percentage quantity of titanium dioxide;
at least one neutral paint which docs n t have coating product comprising the same components of said white paint with the exception of the titanium dioxide;
providing an empty container;
filling the container with a predetermined quantity of paint which is obtained by mixing the white paint and the neutral coating product at variable proportions between 0% and 100% in order to obtain a resultant paint which has a content of titanium dioxide which is selected between a maximum, corresponding to the content of titanium of the white paint, and 0%, corresponding to the content of titanium of the neutral coating product.

2. A method according to claim 1, wherein the group of fluid products further comprises a plurality of fluid colorant components which are different from each other, the method further comprising the step of adding to the paint resulting from the mixing of from 0% to 100% of the white paint and the neutral coating product a variable proportion of one or more fluid colorant components in order to obtain a resultant paint which is correspondingly coloured.

3. A method according to claim 1, wherein the variable proportions from 0% to 100% of the white paint and the neutral coating product are determined by volume and discharged by a volumetric dispensing device.

4. A method according to claim 1, wherein the white paint and the neutral coating product each comprise at least one binding emulsion, at least a quantity of fillers and at least a quantity of additives, which are compatible in the white paint and the coating product, respectively, in order to promote the compatible mixing thereof during the production of the resultant paint.

5. A method according to claim 1, wherein at the end of the filling operation the container contains a resultant quantity of paint which is equal to or greater than 50 cc.

6. A method according to claim 5, wherein at the end of the filling operation the container contains a quantity of paint which is not greater than 200 cc.

7. (canceled)
